(19) United States
(12) Patent Application Publication
(10) Pub. No.: US 2015/0116772 A1
(43) Pub. Date: Apr. 30, 2015

(54) PRINTING DEVICE AND OPERATING METHOD THEREOF

(71) Applicant: HITI DIGITAL, INC., New Taipei City (TW)

(72) Inventors: Hong-Shun Chiou, New Taipei City (TW); Chia-Wei Chien, New Taipei City (TW)

(21) Appl. No.: 14/526,417

(22) Filed: Oct. 28, 2014

Related U.S. Application Data
(60) Provisional application No. 61/897,231, filed on Oct. 30, 2013.

(30) Foreign Application Priority Data
Sep. 10, 2014 (TW) 103131177

(51) Int. Cl. G06F 3/12; H04N 1/00; G06K 15/00

(52) U.S. Cl. CPC G06F 3/1292; G06F 3/1236; G06K 15/405; H04N 1/00278
USPC 358/1.15

(57) ABSTRACT

A printing device and an operating method thereof are disclosed herein. The printing device includes a reading module, a network module and a printing module. The reading module is configured to read a first data from an external storage device, in which the external storage device is electrically coupled to the reading module. The network module is electrically coupled to the reading module. The network module is configured to transmit the first data to an electronic device and to receive second data from the electronic device according to a first wireless networking standard. The printing module is electrically coupled to the reading module and the network module. The printing module is configured to print the first data provided by the reading module or the second data provided by the network module according to a control signal transmitted by the electronic device.

### RELATED APPLICATIONS

This application claims the priority benefit of U.S. Provisional Application Ser. No. 61/897,231 filed Oct. 30, 2013, and Taiwan Application Serial Number 103131177 filed on Sep. 10, 2014 which are herein incorporated by reference.

### BACKGROUND

1. Field of Invention

The present disclosure relates to a printing device. More particularly, the present disclosure relates to a printing device having a wireless card reading function.

2. Description of Related Art

In recent years, due to the rapid development of electronic technologies, mobile phone or tablet has become one of the indispensable tools in modern life. On the other hand, the rise of social network and the high transmission rate of Internet make people acquire the latest information without using slow media such as television, newspapers or books.

In general, it is not a problem for users share to information (for example: file or image) inside the phone or tablet on the Internet. The users can even send data to the printer through a wireless network so as to print documents or images into papers or photos. Due to the limited storage capacity of the mobile phone or of the tablet, the information explosion and also the advancement of digital photography technology, file size of each type of data has increased significantly. As a result, users often need to backup data to an external storage device.

However, mobile phones or tablets typically do not support a variety of external storage devices, thus using a mobile phone or tablet to edit and print the data in the external storage device usually requires complicated procedures. For example, when the user wants to use smart phones to edit photos in the memory card and print out the edited photos, the user needs to use a device with card reading function so as to transfer the photos to your phone. Subsequently, the user needs to use the phone transfer the edited photos to the printer so as to print out the edited photos. Therefore, the users cannot efficiently use the mobile phones to edit or print the data stored in the external storage device.

Based on those mentioned above, how to allow users to use mobile devices to edit and print data in the external storage devices more intuitively is one of the current research topics.

### SUMMARY

The disclosure provides a printing device. The printing device includes an external connect module, a network module and a print module. The external connect module is configured to read a first data in an external storage device. The network module is electrically coupled to the external connect module, and the network module is configured to transmit the first data to an electronic device according to a first wireless networking standard and to receive a second data transmuted by the electronic device. The print module is electrically coupled to the external connect module and the network module, and the print module is configured to print the first data provided by the external connect module or the second data provided by the network module according to a control signal transmitted by the electronic device.

The disclosure provides an operating method. The operating method is suitable for a printing device and an electronic device, in which the printing device includes a external connect module, a network module and a print module, and the operating method includes the following steps: reading a first data in a external storage device by the external connect module; transmitting the first data to the electronic device by the network module according to a first wireless networking standard; receiving a second data, which is transmitted by the electronic device, by the network module according to the first wireless networking standard; and printing the first data provided or the second data by the print module according a control signal transmitted by the electronic device, in which the first data is provided by the external connect module, and the second data is provided by the network module.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a system of a printing device and electronic devices according to one embodiment of this disclosure;

FIG. 2 is a block diagram illustrating a printing device according to one embodiment of this disclosure;

FIG. 3 is a schematic diagram illustrating a system of a printing device and a electronic device according to one embodiment of this disclosure;

FIG. 4 is a schematic diagram illustrating a system of a printing device and a electronic device according to one embodiment of this disclosure;

FIG. 5 is a schematic diagram illustrating a system of a printing device and a electronic device according to one embodiment of this disclosure; and

FIG. 6 is a flow diagram illustrating an operation method according to one embodiment of this disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

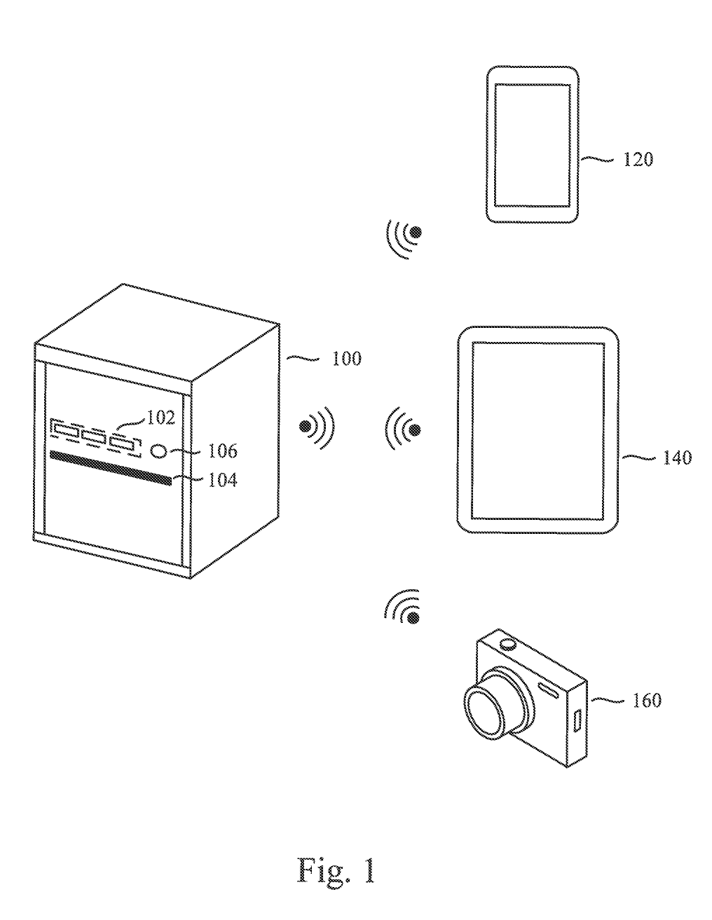

Refer to FIG. 1, a schematic diagram illustrating a system of a printing device 100 and electronic devices 120, 140, 160 according to one embodiment of this disclosure. The printing device 100 includes an external connect module 102, a printing module 140 and a switch 106. The printing device 100 and the electronic devices 120, 140, 160 are respectively equipped with a function of wireless transmission, which makes the electronic devices 120, 140, 160 be configured to connect to the printing device 100 according to a wireless networking standard and to transmit data which is about to print to the printing device 100. In the present embodiment, the electronic device 120 is a mobile phone, the electronic device 140 is a tablet, and the electronic device 160 is a digital camera.

In some embodiments, the wireless networking standard may be wireless fidelity (Wi-Fi), Bluetooth, Wi-Fi Direct or near field communication (NFC).

In some embodiments, the printing device may be a portable printing device.

The external module 102 is electrically coupled to at least one external storage device and configured to read the data from the external storage device and to write the data in the external storage device, in which the external storage device may be a CF card, a SD card, a flash, an external hard disk or a storage device with a function of storing data.

The printing module 104 is configured to print data provided by the external module 102 according to a control signal transmitted by the electronic devices 120, 140, 160, or to print data transmitted by the electronic devices 120, 140, 160 through the corresponding wireless network.

The switch 106 is configured to control a power status of the printing device 100.

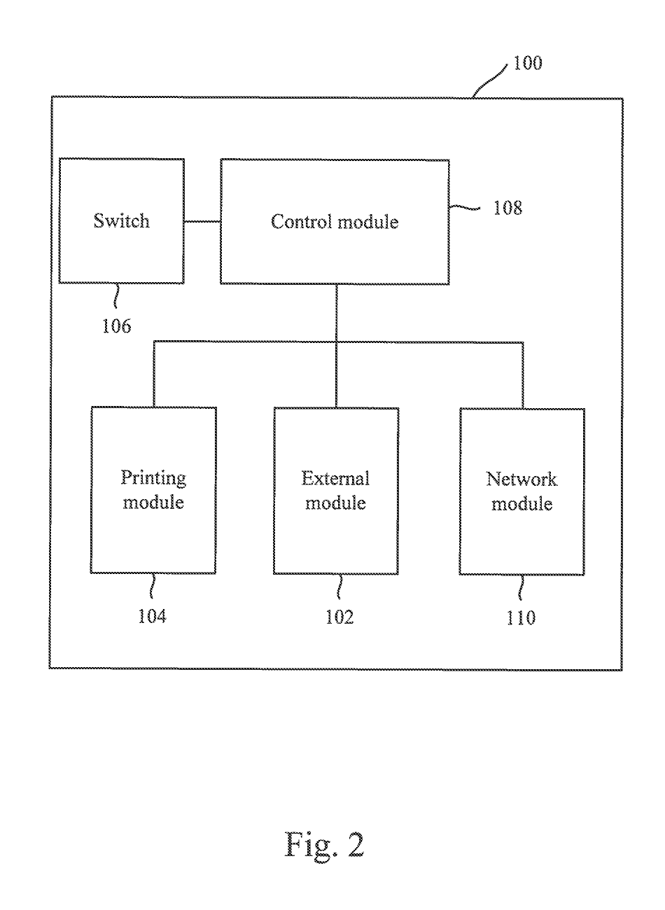

Referring also to FIG. 2, a block diagram illustrating a printing device 100 according to one embodiment of this disclosure. Compared to the printing device shown in FIG. 1, the printing device 100 shown in FIG. 2 further comprises a control module 108 and a network module 110, in which the control module 108 and the network module 110 are not shown in the FIG. 1. The switch 106 is electrically coupled to the control module 108, and the external module 102, the printing module 104, the control module 108 and the network module are electrically coupled to each other.

The control module 108 is configured to transmit control signals to the external module 102, the printing module 104 and the network module 110, or to receive feedback data or signals from the external module 102, the printing module 104 and the network module 110.

In some embodiments, the control module may be a micro controller unit.

The network module 110 is configured to connect the electronic devices 120, 140, 150 through the wireless networking standard. It would be noted that the network module 110 may directly or indirectly transmit the data read by the external module 102 to the electronic devices 120, 140, 160. For example, the network module 110 may receive the data read by the external module 102 through the control module 108. On the other hand, the network module 110 may receive the data transmitted by the electronic devices 120, 140, 160 and directly or indirectly writes the data in the external storage device electrically connected to the external module 102. In addition, the network module 110 may further receive commands transmitted from the electronic devices 120, 140, 160 and transmit the commands to the control module such that the control module 108 can execute the operation corresponding to the commands.

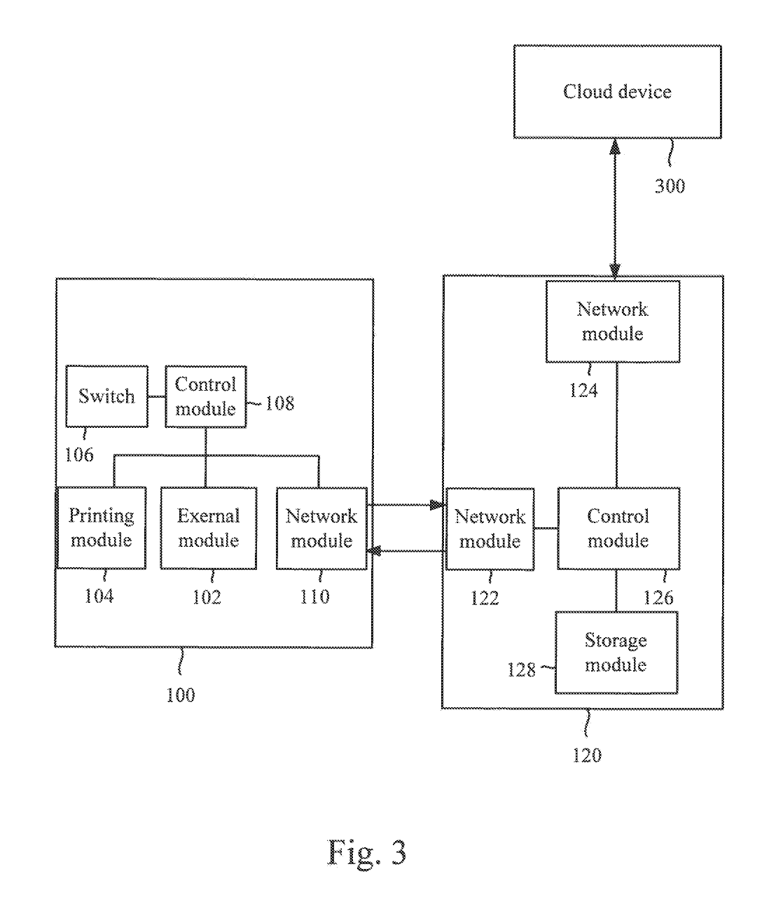

Referring to FIG. 3, a schematic diagram illustrating a system of a printing device 100 and an electronic device 120 according to one embodiment of this disclosure. The electronic device 120 includes a network module 122, a network module 124, a control module 126 and a storage module 128. The present embodiment takes a single electronic device 120 as an example, but it is not limited thereto.

The network module 122 is configured to connect to the network module 110 of the printing device 100 according to a wireless networking standard.

The network module 124 is configured to connect the cloud device according to a wireless networking standard, in which the network module 122 and the network module 124 can be the same network module or the different network modules. In other words, the network module 122 and the network module 124 use the same wireless networking standards or different wireless networking standards.

The control module 126 is configured to control the network module 122, the network module 124 and the storage module 128 so as to control the data transmission between the electronic device 120 and the printing device 100 and the data transmission between the electronic device 120 and a cloud device 300.

The storage module 128 is configured to store the data, in which the data may be an image or a document.

In the present embodiment, the electronic device 120 connects to the network module 110 by the network module 122. The electronic device 120 directly reads data in the external storage device which is electrically coupled to the external module 102 or indirectly reads data in the external storage device through the control module 108. In addition, the electronic device 120 uses the mentioned path to directly write or to indirectly write data to the external storage device. Therefore, the electronic device 120 is configured to read data in the external storage device and to edit the data. Subsequently, the edited data is written to the external storage module or printed out by the print module 104.

For example, when a user would like to use the electronic device 120 to print out a photo in a memory card, the user connects the memory card to the external module 102 and receives the photo by the electronic device through the network module 110 and the network module 122. When there is a need to edit the photo, the user can use photo-editing software in the electronic device 120 to edit the photo since the electronic device is equipped with a flat display panel (not drawn). Subsequently, the user sends the edited photo to the memory card and transmits a control command to the printing device 100. As a result, the control module 108 transmits control signals to the printing module 104 and the external module such that the edited photo in the external storage device is printed out by the printing module 104.

It should be noted that the printing device 100 nowadays are not equipped with functions of editing the documents and of editing the photos, and, in addition, the electronic device 120, e.g., the mobile phone, has the functions of editing the files and controlling the printing device 100. Therefore, in some embodiments, the printing device 100 does not include a flat display module, and the electronic device 120 which is equipped with a flat display module can provide the user with a display interface, such that the user can edit the files which are about to be printed by the print module 104 or acknowledge the operating state of the printing device 100.

Moreover, the electronic device 120 can also use the network module 122 to transmit data stored in the storage module 128 to the printing device 100 such that the data could be printed out by the printing module 104 or stored in an external storage device by the external module. Furthermore, the electronic device 120 is configured to edit the data stored in the storage module 128 and transmit the edited data to the printing device 100 so as to print the edited data out by the printing module or to store the data to the external storage device by the external module 102.

In addition, the electronic device 120 can father transmit data stored in the cloud device 300 to the printing device 100 such that the data could be printed out by the printing module 104 or stored in an external storage device by the external module 102. Furthermore, the electronic device 120 is configured to edit the data stored in the cloud device 300 and transmit the edited data to the printing device 100 so as to print the edited data out by the printing module or to store the data to the external storage device by the external module 102.

In some embodiments, the electronic device 120 is configured to backup data received by the network module 122 or by the network module 123 to the cloud device 300, or the electronic device 120 is configured to backup the result of editing the mentioned data to the cloud device 300.

In some embodiments, the electronic device 120 is also configured to send control commands to the cloud device 300 such that the cloud device 300 can directly sends data which is about to be printed to the printing device 100.

In some embodiments, when the network module 110 transmits data to the electronic device 120, the network module 110 or the electronic module 120 is further configured to back up the transmitted data to the cloud device 300.

Based on those mentioned above, the printing device 100 provided by the present disclosure can effectively perform data transmission between the electronic device 120 and the printing device 100 and data transmission between the cloud device 300 and the printing device 100. Moreover, the printing device 100 effectively use functions of editing documents and photos of the electronic device 120 such that the user can edit or print data stored in the external storage device, storage module 128 and cloud device 300.

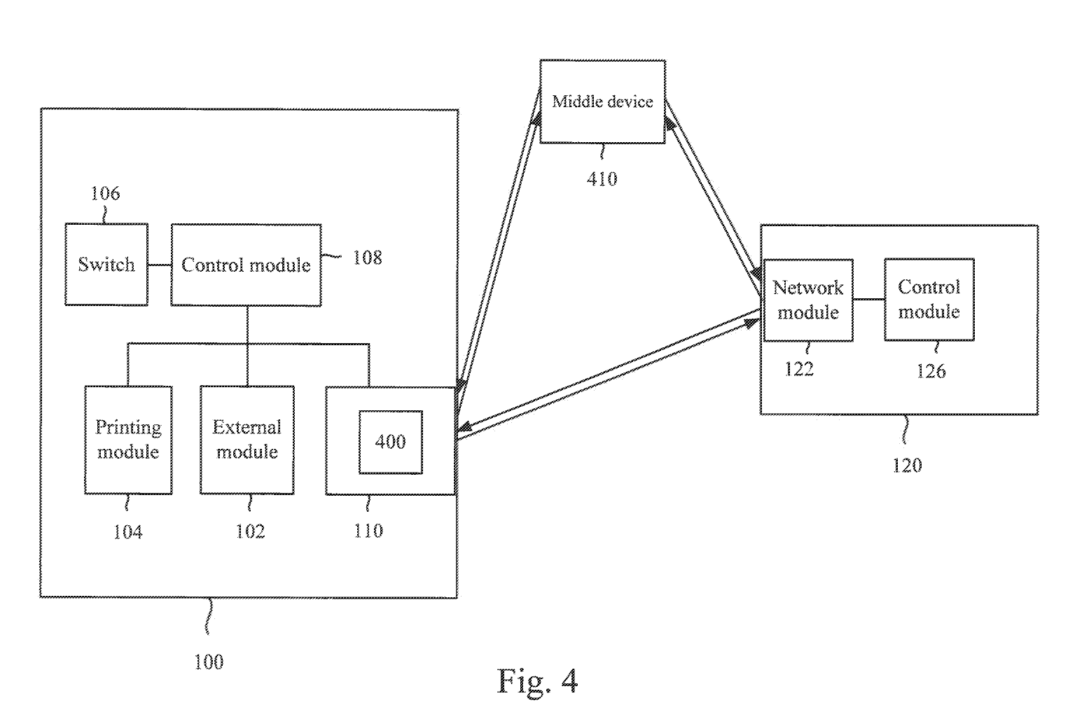

Referring to FIG. 4, a schematic diagram illustrating a system of a printing device 100 and an electronic device 120 according to one embodiment of this disclosure. Compared to FIG. 3, the network module 110 of the printing device 100 shown in FIG. 4 further comprises a network serving element 400, and the network module 110 can further connect to the network module 122 of the electronic device 120 through a middle device 410.

The network serving element 400 has a specific network address, in which the network serving element 400 is configured to provide an operating interface to a flat display panel of the electronic device 120 such that the user can directly control the printing device 100 using the electronic device 120.

In some embodiments, the middle device 410 may be a wireless access point, a base station, a wireless relay or other devices which can relay the data or the control signal.

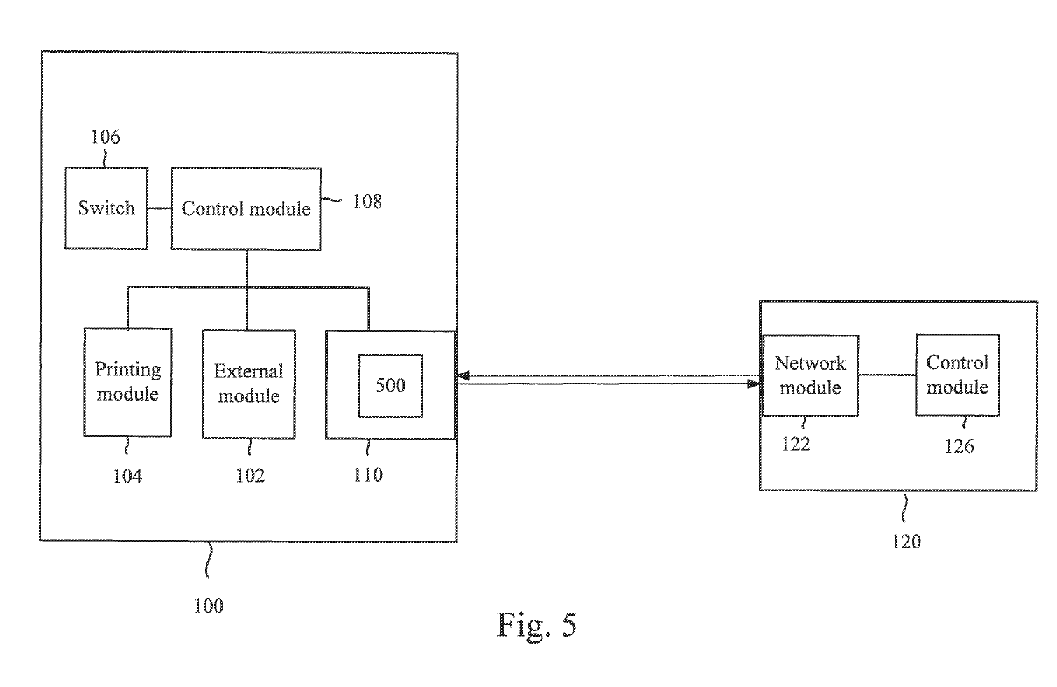

Referring to FIG. 5, a schematic diagram illustrating a system of a printing device 100 and an electronic device 120 according to one embodiment of this disclosure. Compared to FIG. 3, the network module 110 of the printing device 100 shown in FIG. 4 further comprises a command receiving element 500, and the command receiving element 500 is configured to receive commands transmitted by an application program, e.g., APP, stored in the electronic device 120, in which the commands are configured to control the operation of the printing device 100.

In some embodiments, the wireless networking standards shown in FIG. 4 and FIG. 5 are the same wireless networking standard or the different wireless networking standards compared to the wireless networking standard shown in FIG. 3.

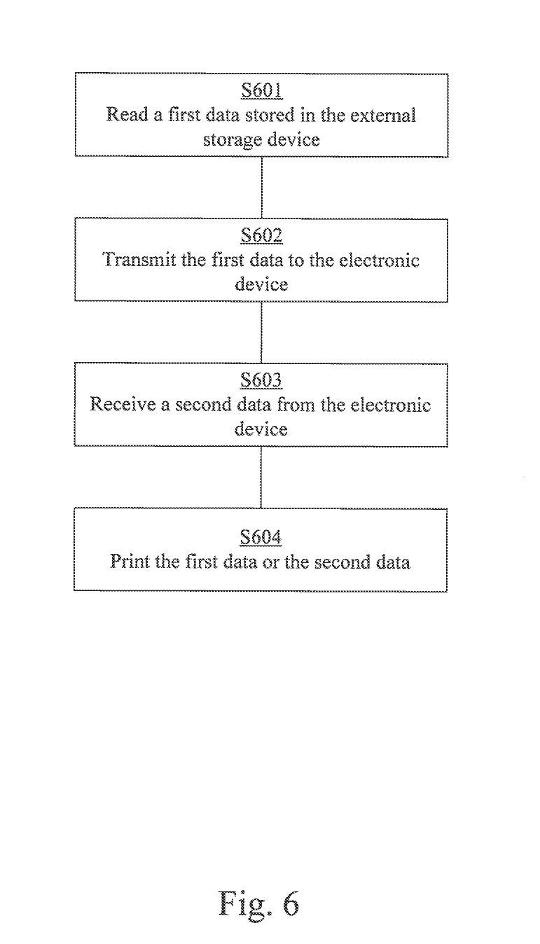

Referring to FIG. 6, a flow diagram illustrating an operation method according to one embodiment of this disclosure. The operation method is suitable between the printing device 100 and the electronic device 120, and the operation method comprises the following steps.

In steps S601, a first data stored in an external storage device is read by the external module 102 of the printing device 100.

In steps S602, the first data is transmitted to the electronic device 120 by the network module 110 according to a wireless networking standard.

In steps S603, a second data is transmitted by the electronic device 120 is then received by the network module 110 according to the wireless networking standards.

In some embodiments, the electronic device 120 is configured to edit the first data to the second data.

In steps S604, the printing module 104 prints the first data provided by the external module 102 or the second data provided by the network module 110.

Based on those mentioned above, the printing device and operating method thereof provided by the present disclosure can let the user to effectively and easily edit or print the data stored in an external storage device.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A printing device, comprising:
an external connect module, configured to read a first data in a external storage device;
a network module electrically coupled to the external connect module, configured to transmit the first data to an electronic device according to a first wireless networking standard, and to receive a second data transmitted by the electronic device; and
a print module electrically coupled to the external connect module and the network module, configured to print the first data provided by the external connect module or the second data provided by the network module according to a control signal transmitted by the electronic device.

2. The printing device of claim 1, wherein the electronic device is configured to edit the received first data to the second data, and to transmit the second data to the network module so as to provide the second data to the print module for printing the second data.

3. The printing device of claim 1, wherein the electronic device is configured to receive the second data from a cloud device, or to read the second data from a storage module of the electronic device, such that the second data is transmitted to the network module.

4. The printing device of claim 1, wherein the electronic device is configured to receive a third data from a cloud device, or to read the third data from a storage module of the electronic device, and the electronic device is further configured to edit the third data to the second data so as to transmit the second data to the network module.

5. The printing device of claim 2, wherein the printing device is further configured to transmit the second data to the cloud device.

6. The printing device of claim 1, wherein the external connect module is further configured to store the second data received by network module in the external storage device.

7. The printing device of claim 1, wherein when the network module transmits the first data tot the electronic device, the network module or the electronic device is configured to backup the first data to a cloud device.

8. The printing device of claim 1, wherein the network module further comprises:
a network serving element having a specific network address, wherein when the electronic device connects to the specific network address according to a second wireless networking standard, the network serving element is configured to provide an operating interface on a flat display module of the electronic device.

9. The printing device of claim 1, wherein the network module further comprises:
an command receiving element, configured to receive at least one command transmitted by an application program of the electronic device according to a second wireless networking standard, in which the at least one command is configured to control the operation of the printing device.

10. The printing device of claim 9, wherein the first wireless networking standard and the second wireless networking standard are a same wireless networking standard or different wireless networking standards.

11. An operating method, suitable for a printing device and an electronic device, wherein the printing device comprises a external connect module, a network module and a print module, and the operating method comprises:
reading a first data in a external storage device by the external connect module:
transmitting the first data to the electronic device by the network module according to a first wireless networking standard;
receiving a second data, which is transmitted by the electronic device, by the network module according to the first wireless networking standard; and
printing the first data provided or the second data by the print module according a control signal transmitted by the electronic device, in which the first data is provided by the external connect module, and the second data is provided by the network module.

12. The operating method of claim 11, wherein the electronic device is configured to edit the first data received by the network module to the second data, and to transmit the second data to the network module so as to provide the second data to the print module for printing the second data.

13. The operating method of claim 11, wherein the second data is received by the electronic device from a cloud device such that the second data is transmitted by the electronic device to the network module.
